(19) United States
(12) Patent Application Publication
(10) Pub. No.: US 2026/0014943 A1
(43) Pub. Date: Jan. 15, 2026

(54) Cable Holding Device

(71) Applicants: HI-LEX Corporation, Takarazuka-shi (JP); Toyota Boshoku Kabushiki Kaisha, Kariya-shi (JP)

(72) Inventors: Tomoyoshi Okada, Takarazuka-shi (JP); Fumihiko Matsuyama, Kariya-shi (JP); Tatsuya Fukuoka, Kariya-shi (JP)

(21) Appl. No.: 18/993,239

(22) PCT Filed: Jun. 28, 2023
(86) PCT No.: PCT/JP2023/023916

§ 371 Date: Jan. 10, 2025

(30) Foreign Application Priority Data
Jul. 13, 2022 (JP) 2022-112624

(51) Int. Cl. B60R 16/02; B60N 2/02; B60N 2/90

(52) U.S. Cl. CPC B60R 16/0215; B60N 2/90; B60N 2/0224

(57) ABSTRACT

Provided is a cable holding device with which an unlocked portion of a cable does not easily become a hindrance. A cable holding device (11) includes: a body (19) extending in a specific plane and including an attachment section configured to, with the specific plane facing a seating surface of a seat of a vehicle, attach the body (19) to a seat component of the seat; a lock (21) configured to lock at least a portion of a cable (24) provided for the seat; and a restrictor (22) configured to prevent an unlocked portion (24b) from being moved in a predetermined direction, the unlocked portion (24b) being of the cable (24) at least a portion of which is locked by the lock (21) and being not locked by the lock (21).

### CROSS-REFERENCE TO RELATED APPLICATIONS

This application is the United States national phase of International Patent Application No. PCT/JP2023/023916 filed Jun. 28, 2023, and claims priority to Japanese Patent Application No. 2022-112624 filed Jul. 13, 2022, the disclosures of which are hereby incorporated by reference in their entireties.

### BACKGROUND OF THE INVENTION

### Field of the Invention

The present invention relates to a cable holding device including: a body extending in a specific plane and including: an attachment section configured to, with the specific plane facing a seating surface of a seat of a vehicle, attach the body to a seat component of the seat; and a lock configured to lock at least a portion of a cable provided for the seat.

### Description of Related Art

Japanese Unexamined Patent Application Publication, Tokukai, No. 2020-60203 (JP 2020-60203) discloses how operation cables are provided for a seat component of a seat. Specifically, the operation cables are attached to a seat frame as a seat component with use of attachment members.

In a case where operation cables are attached to a seat frame with use of attachment members as disclosed in JP 2020-60203, the cables are attached to two or more portions of the seat frame with use of two or more attachment members. This raises such issues as an increase in the number of parts and a complicated step of attaching operation cables to the seat frame.

Such issues may be solved by using a cable holding device for holding cables. The term “cables” as used in this specification refers to flexible, elongated members such as an electric wire or a bundle of electric wires for transmitting electric signals, an optical fiber or a bundle of optical fibers for transmitting optical signals, and/or a wire for motive power transmission. International Publication No. 2022/039906 discloses a cable holding device including a

body with two or more locks configured to lock elongated cables. The cable holding device is attached to a seat component with cables held by the body at two or more positions. The use of the cable holding device simplifies the step of attaching cables to a seat component and solves the issue of an increase in the number of parts involved in the attachment.

### SUMMARY OF THE INVENTION

With elongated cables attached to a seat component with use of the cable holding device, the cables are locked on the two or more locks of the cable holding device. This, however, leaves an unlocked portion, that is, a portion not locked on the locks and freely movable relative to the cable holding device.

If the seat is moved in a direction such as the front-rear direction or the vertical direction with the cable holding device attached to a seat component, an unlocked portion of each cable may be moved to come into contact with another component such as a seat rail, for instance, be caught by another component or held between other components and thereby damaged.

Further, when the user attaches the cable holding device holding cables to a scat component, the unlocked portion may be caught by the seat component, thereby hindering the attachment.

The present invention has been accomplished in view of the above issue, and has an object of providing a cable holding device with which an unlocked portion of a cable does not easily become a hindrance.

To attain the above object, a cable holding device according to the present invention characteristically includes: a body extending in a specific plane and including: an attachment section configured to, with the specific plane facing a seating surface of a seat of a vehicle, attach the body to a seat component of the seat; a lock configured to lock at least a portion of a cable provided for the seat; and
a restrictor configured to prevent an unlocked portion from being moved in a predetermined direction, the unlocked portion being of the cable at least a portion of which is locked by the lock and being not locked by the lock.

With the above characteristic configuration, the body includes a restrictor configured to prevent the unlocked portion of the cable from being moved in a predetermined direction. The restrictor prevents an unlocked portion of the cable from coming into contact with another component and being caught by another component or held between other components, thereby reducing the risk of the cable being damaged.

Further, when the user attaches the cable holding device holding the cable to a seat component, the restrictor prevents the unlocked portion of the cable from being caught by another seat component, so that the unlocked portion will not hinder the attachment.

In addition, with the cable locked on the lock of the cable holding device, the restrictor prevents the unlocked portion from being freely moved in any direction, but only allows the unlocked portion to be moved in limited directions, so that the cable holding device holds the cable in a compact manner. The restrictor thus advantageously allows a person to easily move, for example, place into a box, the cable holding device with the cable locked on the lock.

The above configuration provides a cable holding device with which an unlocked portion of a cable does not easily become a hindrance.

The cable holding device according to the present invention may characteristically be further configured such that the restrictor includes one or more extending members extending from the body in a direction intersecting the specific plane.

With the above characteristic configuration, with a cable routed along the body (which extends in the specific plane), the one or more extending members extend from the body in a direction intersecting the specific plane and prevent the cable from being moved in a predetermined direction.

The cable holding device according to the present invention may characteristically be still further configured such that the restrictor includes one or more extending members extending from a predetermined linear area of a face of the body in a direction intersecting the specific plane.

With the above characteristic configuration, the restrictor prevents the cable from being moved in a predetermined direction across not a limited area but an extended area of the face of the body, that is, across the length of the predetermined linear arca.

The cable holding device according to the present invention may characteristically be still further configured such that the seat is movable in a front-rear direction of the vehicle, and the predetermined direction is orthogonal to the front-rear direction.

With the above characteristic configuration, with the seat movable in the front-rear direction of the vehicle with use of seat rail units or the like, the restrictor prevents the cable from being moved in a direction orthogonal to the front-rear direction or to the seat rail units or the like. The restrictor prevents the unlocked portion of the cable from coming into contact with the members of the seat rail units or the like.

### BRIEF DESCRIPTION OF THE DRAWINGS

FIG. 1 is a diagram illustrating a seat of a vehicle.

FIG. 2 is a diagram schematically illustrating a seating section as a seat component.

FIG. 3 is a diagram schematically illustrating a cable holding device.

FIG. 4 is a diagram schematically illustrating a cable holding device.

FIG. 5 is a diagram illustrating a seat frame with a cable holding device attached thereto.

FIG. 6 is a diagram illustrating a cable holding device holding cables.

FIG. 7 is a diagram illustrating a cable holding device.

FIG. 8 is a diagram illustrating a cable holding device.

### DESCRIPTION OF THE INVENTION

The description below deal with a cable holding device 11 as an embodiment of the present invention with reference to drawings. The cable holding device 11 as the present embodiment is provided for a seat 1 of a vehicle such as an automobile as an example. The drawings show “X” to indicate the front-rear direction of the vehicle, “Y” to indicate the left-right direction of the vehicle, and “Z” to indicate the up-down direction of the vehicle.

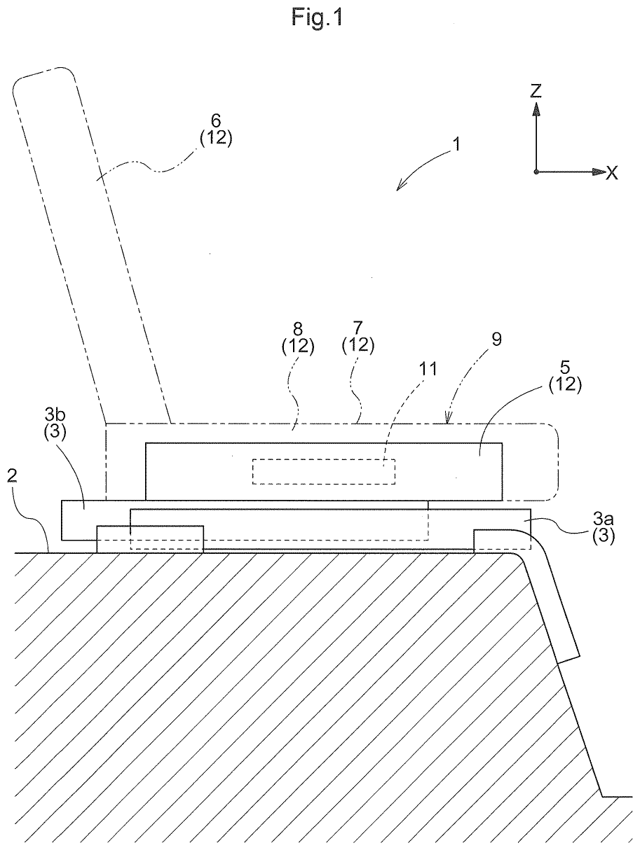

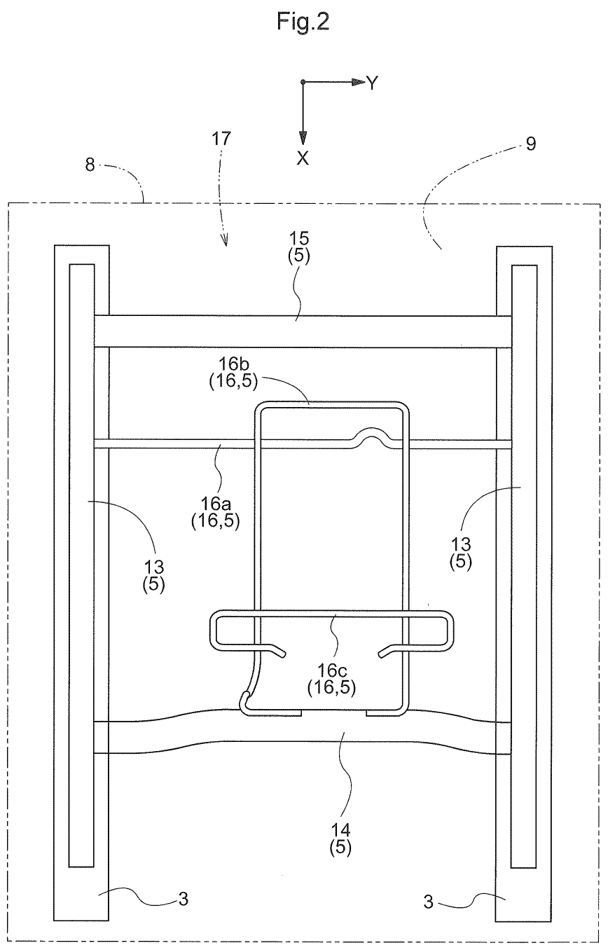

FIG. 1 is a diagram schematically illustrating a seat 1 of a vehicle. FIG. 2 is a diagram schematically illustrating a seating section 7 as a seat component 12.

The vehicle, as illustrated, includes a floor section 2 and seat rail units 3 disposed on the floor section 2 and supporting the seat 1. The seat rail units 3 each include a lower rail 3a fixed to the floor section 2 and an upper rail 3b slidable relative to the lower rail 3a. FIG. 1 illustrates an example in which the upper rails 3b are slidable, that is, the seat 1 is movable, in a direction along the X direction. The X direction being the front-rear direction of the vehicle, the seat 1 is movable in the front-rear direction of the vehicle.

The seat 1 includes a combination of seat components 12. The seat 1 includes, as seat components 12, a seating section 7 on which an occupant of the vehicle is able to sit and a backrest 6 on which the occupant is able to lean. The seating section 7 includes, as seat components 12, a cushion pad 8 that provides a seating surface 9 of the seat 1 and a seat frame 5 as a framework of the seating section 7.

The seat 1 includes a reclining device (not illustrated in the drawings) configured to swing the backrest 6 in the front-rear direction of the vehicle and a forward-backward movement device (not illustrated in the drawings) configured to move the entire seat 1 in the front-rear direction of the vehicle. The reclining device and the forward-backward movement device may be, for example, of an electrically operable type or a manually operable type. The former is configured to move the backrest 6 or the seat 1 in response to an occupant operating a switch to actuate a motor or the like provided for the seat 1. The latter is configured such that the reclining device and the forward- backward movement device normally remain mechanically locked and inoperable and become operable in response to an occupant operating a lever or the like to mechanically unlock the reclining device and the forward-backward movement device.

For instance, in response to an occupant operating an operation lever (not illustrated in the drawings) of the reclining device, the operating force then applied is transmitted through a wire for motive power transmission to an unlocking lever of the backrest 6 to unlock and recline the backrest 6.

As described above, the seat 1 is provided with flexible, elongated cables 24 such as an electric wire or a bundle of electric wires for transmitting electric signals, an optical fiber or a bundle of optical fibers for transmitting optical signals, and/or a wire for motive power transmission, for the respective operations of the reclining device and the forward-backward movement device. The cables 24 will be further described later.

The seat frame 5 as a seat component 12 includes two side frame members 13, a front pipe 14, a rear pipe 15, and cushion pad supports 16 (namely, a first cushion pad support 16a, a second cushion pad support 16b, and a third cushion pad support 16c). The seating section 7 is a combination of the seat frame 5 with the cushion pad 8 overlayed thereon. The seating section 7 has an upper face as a seating surface 9 on which an occupant is able to sit, meaning that the cushion pad 8 is on the seating surface 9.

The side frame members 13 extend in the X direction and are apart from each other in the Y direction. The side frame members 13 are attached to the respective upper rails 3b.

The front pipe 14 extends in the Y direction and couples the side frame members 13 to each other. The rear pipe 15 extends in the Y direction and couples the side frame members 13 to each other.

The first to third cushion pad supports 16a to 16c are each made of, for example, an elastically deformable wire such as a metal wire. The first to third cushion pad supports 16a to 16c are below the cushion pad 8 and are configured to receive a load applied to the cushion pad 8 by an occupant sitting on the seating surface 9.

The first cushion pad support 16a extends in the Y direction and couples the side frame members 13 to each other. The second cushion pad support 16b is U-shaped and has opposite ends attached to the front pipe 14. The third cushion pad support 16c lies on two or more portions of the second cushion pad support 16b. FIG. 2 illustrates an example in which the cushion pad supports 16, namely the first to third cushion pad supports 16a to 16c, have a space facing a central portion of the seating area 17 of the seating surface 9.

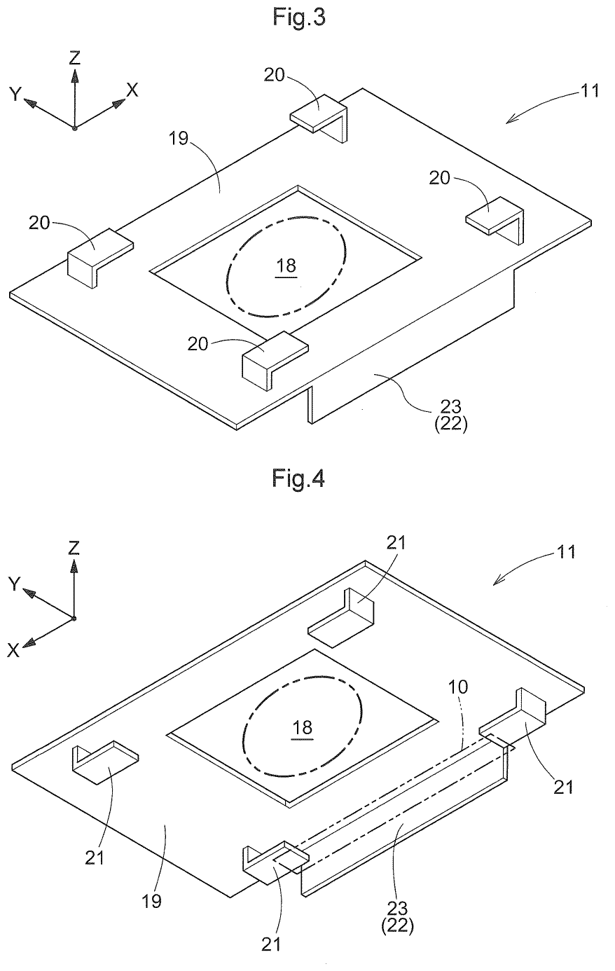

FIGS. 3 and 4 are each a diagram schematically illustrating a cable holding device 11. FIG. 3 is a top perspective view of the cable holding device 11, whereas FIG. 4 is a bottom perspective view of the cable holding device 11.

The cable holding device 11, as illustrated, includes a body 19 extending in a specific plane and including attachment sections 20 and locks 21. The attachment sections 20 serve to attach the body 19 to a seat component 12 of the seat 1 of the vehicle with the specific plane facing the seating surface 9 of the seat 1. The locks 21 serve to lock at least part of the cables 24 provided for the seat 1. The specific plane for the present embodiment is an XY plane as an example. The body 19 as the example illustrated is in the shape of a loop extending in the specific plane and having a central space as a central arca 18.

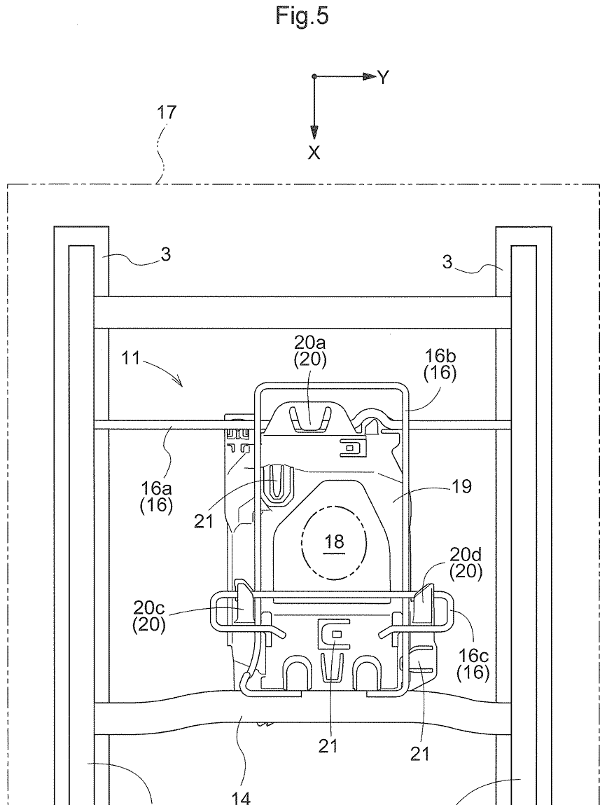

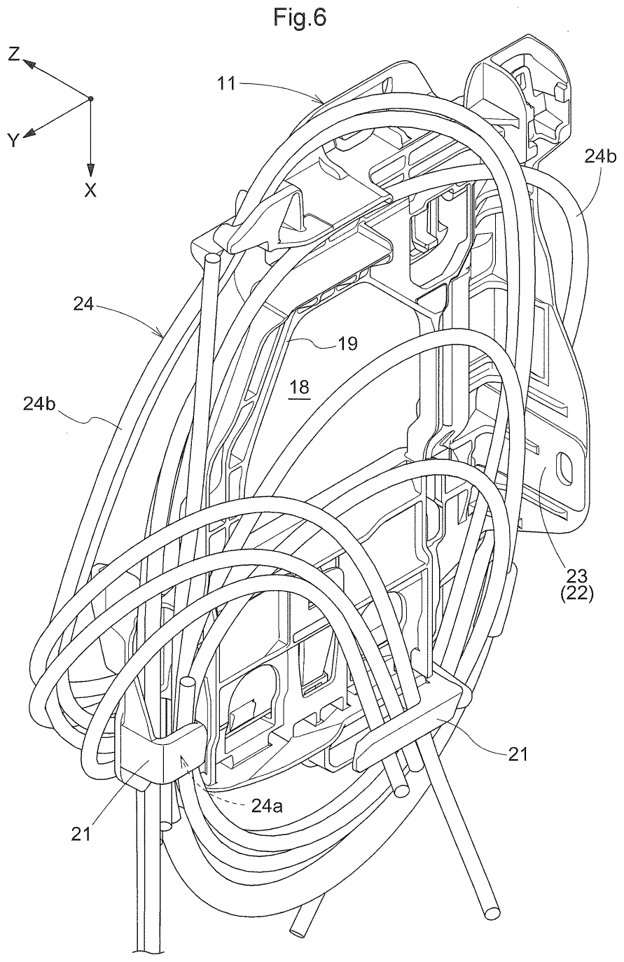

FIG. 5 is a diagram illustrating the seat frame 5 with the cable holding device 11 attached thereto. FIG. 6 is a diagram illustrating the cable holding device 11 holding cables 24. The body 19 of the cable holding device 11, as illustrated, extends in a specific plane (that is, the XY plane in the drawings).

The body 19 includes attachment sections 20 and locks 21. The body 19 is attached to the cushion pad supports 16 as a seat component 12 with use of the attachment sections 20. Specifically, the attachment sections 20 include an attachment section 20a, an attachment section 20c, and an attachment section 20d, the attachment section 20a being attached to the first cushion pad support 16a, the attachment sections 20c and 20d being attached to the third cushion pad support 16c.

The body 19 is shaped to be positioned below and near the cushion pad supports 16. The cushion pad supports 16 have a space facing a central portion of the seating area 17 of the seating surface 9 across a space. The body 19 has a space in the central area 18, which faces a central portion of the seating area 17 of the seating surface 9.

As described above, the body 19 is in the shape of a loop extending in a specific plane. This allows the body 19 to be so positioned as to have a central space facing a central portion of the seating area 17 of the seating surface 9. The body 19 has a space in the central area 18, which faces a central portion of the seating arca 17 of the seating surface 9. This prevents the body 19 from easily receiving a heavy load applied to a central portion of the seating area 17 of the seating surface 9 when a person sits on the seat 1. The cushion pad supports 16 reduce the amount by which the cushion pad 8 is dented when a person sits on the seat 1, at and near the portions at which the cushion pad supports 16 are disposed. The body 19 for the present embodiment is shaped to be positioned below and near the cushion pad supports 16. This prevents the body 19 from being easily affected by a dent made in the cushion pad 8 when a person sits on the seat 1. This in turn reduces the risk of the body 19 being damaged by a load applied when a person sits on the seat 1.

As described above, the cables 24 are locked by the locks 21 integrally with the body 19. For instance, the user locks the cables 24 on the body 19, carries the cable holding device 11 (with the cables 24 locked on the body 19), and then attaches the cable holding device 11 to the seat 1. This configuration eliminates the need for such difficult work as attaching cables 24 to a seat component 12 in a narrow space below the seat 1.

The cables 24 as locked on the body 19 of the cable holding device 11 each have locked portions 24a locked by the locks 21 (that is, portions not freely movable) and an unlocked portion 24b not locked by the locks 21 (that is, a portion freely movable). The cable holding device 11 is configured not to fixedly lock the entire cables 24 on the body 19 but to leave an unlocked portion 24b (that is, a portion not locked by the locks 21) in order to allow a large portion of each cable 24 to be freely movable.

For instance, a cable 24 may have a first end locked on the body 19 of the cable holding device 11 attached to the seat 1 and a second end fixed to a device or the like on, for example, the floor of the vehicle. In this state, the distance between the first and second ends changes as a result of an occupant moving the seat 1 in the front-rear direction of the vehicle with use of the forward-backward movement device, that is, in response to the cable holding device 11 being moved relative to, for example, the floor of the vehicle. If the cable 24 did not have a large, freely movable portion between the first and second ends, the distance change would exert strong tension on that portion or force the portion to bend, possibly damaging the cable 24. If a cable 24 has a large, freely movable portion, the distance change will not cause such trouble.

If a cable holding device 11 is simply configured to allow a cable 24 to have a large, freely movable portion, that unlocked portion 24b, which is freely movable away from the body 19 of the cable holding device 11, may be caught by another component or held between other components. The unlocked portion 24b of a cable 24 may be caught by another component or held between other components when, for instance, the user transports the cable holding device 11 (with cables 24 locked on the body 19), places the cable holding device 11 into a packaging box, attaches the cable holding device 11 to a seat component 12, or after the attachment, moves the seat 1 in the front-rear direction of the vehicle with use of the forward-backward movement device.

In view of the above issues, the cable holding device 11 as the present embodiment includes a body 19 provided with a restrictor 22 configured to prevent the unlocked portion 24b of each cable 24 from being moved in a predetermined direction, the unlocked portion 24b being of a cable 24 at least portions of which are locked by the locks 21 and being not locked by the locks 21.

The restrictor 22 prevents the unlocked portion 24b of each cable 24 from coming into contact with another component, being caught by another component, or being held between other components, thereby reducing the risk of the cables 24 being damaged. Further, when the user attaches the cable holding device 11 holding the cables 24 to a seat component 12, the restrictor 22 prevents the unlocked portion 24b of each cable 24 from being caught by another seat component 12, so that the unlocked portion 24b will not hinder the attachment. In addition, with the cables 24 locked on the locks 21 of the cable holding device 11, the restrictor 22 prevents the unlocked portion 24b from being freely moved in any direction, but only allows the unlocked portion 24b to be moved in limited directions, so that the cable holding device 11 holds the cables 24 in a compact manner. The restrictor 22 thus advantageously allows a person to easily carry, for example, place into a packaging box, the cable holding device 11 with the cables 24 locked on the locks 21.

Specifically, the restrictor 22 includes one or more extending members 23 extending from the body 19 in a direction intersecting the specific plane (in the drawings, in a direction along the Z direction, which intersects the XY plane). FIGS. 3, 4, and 6 each illustrate an example in which the restrictor 22 includes a single extending member 23. The restrictor 22 includes one or more extending members 23 extending in a direction along the Z direction from a predetermined linear arca (that is, a linear arca 10) of a face of the body 19. Specifically, the restrictor 22 preferably protrudes in a direction along the Z direction from that face of the body 19 which faces the cables 24. The restrictor 22 illustrated in the drawings protrudes from the body 19 downward relative to the seat 1.

As described above, with cables 24 routed along the body 19 (which extends in the specific plane), the one or more extending members 23 extend from the body 19 in a direction intersecting the specific plane and prevent the cables 24 from being moved in a predetermined direction. The restrictor 22 prevents the cables 24 from being moved in a predetermined direction across not a limited area but an extended area of the face of the body 19, that is, across the length of the linear area 10.

The present embodiment is configured such that the seat 1 is movable in the front-rear direction of the vehicle, whereas the predetermined direction (that is, the direction in which the restrictor 22 prevents the unlocked portion 24b from being moved) is orthogonal to the front-rear direction. With the seat I movable in the front-rear direction of the vehicle with use of the seat rail units 3 as with the present embodiment, the restrictor 22 prevents the cables 24 from being moved in a direction orthogonal to the front-rear direction or to the seat rail units 3 (that is, toward the scat rail units 3). The restrictor 22 prevents the unlocked portion 24b of each cable 24 from coming into contact with the members of the seat rail units 3.

### Alternative Embodiments

The embodiment described above is a specific example of how the cable holding device 11 and the seat 1 are configured. Their respective configurations may be altered as appropriate.

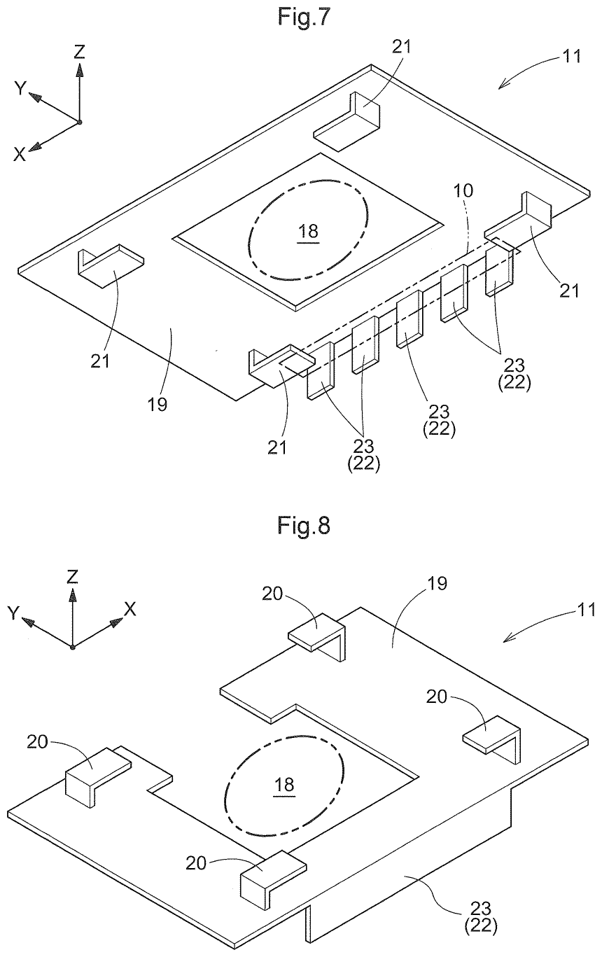

For instance, the restrictor 22 may be altered in shape and number as appropriate. FIG. 7 illustrates an example in which the restrictor 22 includes two or more elongated extending members 23 arranged in the linear area 10. This restrictor 22 also prevents the unlocked portion 24b from being moved in a predetermined direction.

The restrictor 22 may be positioned at any portion of the body 19 as appropriate.

The body 19 of the cable holding device 11 may be altered in shape as appropriate. FIG. 8 illustrates an example body 19 bent in a C shape extending in a specific plane (that is, the XY plane in the drawing) and having a central space as a central area 18. Such a shape allows the body 19 to be so positioned as to be in the shape of a C with a central space facing a central portion of the seating area 17 of the seating surface 9. This prevents the body 19 from easily receiving a heavy load applied to a central portion of the seating area 17 of the seating surface 9 when a person sits on the seat 1.

The attachment sections 20 and locks 21 of the cable holding device 11 may also be altered as appropriate in, for example, shape and number. For instance, the cable holding device 11 may be provided with a publicly known coupler including a case containing a joint piece for connecting respective terminals of two or more cables 24 to couple the cables 24 together so that the cables 24, which extend from the cable holding device 11, are locked on the locks 21.

The cushion pad supports 16 may also be altered as appropriate in shape and number.

The arrangements of each of the embodiments described above (including the alternative embodiments) may be used in combination with an arrangement(s) disclosed for a different embodiment unless such combination causes any contradiction. The embodiments disclosed herein (including the alternative embodiments) are merely examples. The present invention is not limited to such embodiments, and may be varied as appropriate as long as such variation does not prevent an object of the present invention from being attained.

### Industrial Applicability

The present invention is applicable to a cable holding device with which an unlocked portion of a cable does not easily become a hindrance.

### Reference Signs List

1 Seat
7 Seating section
8 Cushion pad
9 Seating surface
10 Linear area
11 Cable holding device
12 Seat component
16 Cushion pad support
16a First cushion pad support
16b Second cushion pad support
16c Third cushion pad support
17 Seating area
18 Central area
19 Body
20 Attachment section
20a Attachment section
20c Attachment section
20d Attachment section
21 Lock
22 Restrictor
23 Extending member
24 Cable
24a Hooked portion
24b Unlocked portion

1. A cable holding device, comprising:
a body extending in a specific plane and comprising:
an attachment section configured to, with the specific plane facing a seating surface of a seat of a vehicle, attach the body to a seat component of the seat;
a lock configured to lock at least a portion of a cable provided for the seat; and
a restrictor configured to prevent an unlocked portion from being moved in a predetermined direction, the unlocked portion being the cable at least a portion of which is locked by the lock and not locked by the lock.

2. The cable holding device according to claim 1, wherein:
the restrictor comprises one or more extending members extending from the body in a direction intersecting the specific plane.

3. The cable holding device according to claim 1, wherein:
the restrictor comprises one or more extending members extending from a predetermined linear area of a face of the body in a direction intersecting the specific plane.

4. The cable holding device according to claim 1, wherein:
the seat is movable in a front-rear direction of the vehicle, and
the predetermined direction is orthogonal to the front-rear direction.
